(19) United States
(12) Patent Application Publication
(10) Pub. No.: US 2014/0297760 A1
(43) Pub. Date: Oct. 2, 2014

(54) MANAGING E-MAIL MESSAGES BETWEEN RELATED ACCOUNTS

(71) Applicant: INTERNATIONAL BUSINESS MACHINES CORPORATION, Armonk, NY (US)

(72) Inventors: Soobaek Jang, Hamden, CT (US); Raghava Reddy Kapu Veera, Bangalore (IN); Rehan Altaf, Round Rock, TX (US); JooYoun Shin, Kyungki-do (KR)

(73) Assignee: International Business Machines Corporation, Armonk, NY (US)

(21) Appl. No.: 13/852,368

(22) Filed: Mar. 28, 2013

(51) Int. Cl. H04L 12/58

(52) U.S. Cl. CPC H04L 51/22
USPC 709/206

(57) ABSTRACT

In a method for managing e-mail messages between related e-mail accounts, an e-mail message is received from a first e-mail account of a user. It is determined that the e-mail message should be listed as a sent e-mail message in a second e-mail account of the user. The e-mail message is listed as a sent e-mail message in the second e-mail account.

### FIELD OF THE INVENTION

The present invention relates generally to the field of electronic mail, and more specifically to managing e-mail messages between related e-mail accounts.

### BACKGROUND OF THE INVENTION

Electronic mail, commonly referred to as e-mail, is a widely used method of exchanging digital messages from an author/sender to one or more recipients. E-mail operates across the Internet or other computer networks. Today's e-mail systems are based on a store-and-forward model. E-mail servers accept and store e-mails from the sender, notify the recipients of the existence of the e-mail by listing the incoming e-mails in an “in-box” of the recipients, and forward the e-mail to the recipients upon their selection and request from the in-box. Neither the sender nor the recipients are required to be online simultaneously; they need connect only briefly, typically to an e-mail server, for as long as it takes to send or receive the e-mail messages.

The use of e-mail is commonplace for personal and business purposes. Electronic files can be attached to and sent with the e-mail messages. E-mail accounts contain a collection of e-mails that are messages sent to and from users via a network. Software is provided to collect and organize e-mail.

Each e-mail account is unique and is associated with a service provider and a user. As e-mail messaging has become a more widespread technology, many users have more than one e-mail account. For example, a user may have a business e-mail account at work, a personal e-mail account at home, a personal e-mail account provided by a portal of the internet service provider, etc. Individuals may therefore possess more than one e-mail account with multiple e-mail service providers, or they may possess more than one e-mail account with the same e-mail service provider. In the latter case, the individual would have different user names and passwords for the different accounts.

To manage multiple e-mail accounts a user must access the mailbox of each account. The user may use several different applications to access different work and personal e-mail accounts, which is a cumbersome and time consuming procedure. A “forwarding” service was known to permit a user to forward incoming e-mails from multiple accounts to a single account in which they can be stored and handled. When using the “forwarding” service, an e-mail message received by an e-mail account which is a named recipient of the e-mail is forwarded to another e-mail account which is not a named recipient of the e-mail but is owned by the same person who owns the named recipient account, the e-mail message appears in the inbox folder of the both e-mail accounts. If the owner responds (with a “reply” or “forward”) to the received e-mail using the other e-mail account, the recipient of the response will see the e-mail address associated with the other e-mail account in the “from” field of the e-mail message. This may confuse the recipient of the response, who may not be familiar with the user's other e-mail address. The message could also be sent to the recipient's spam folder.

### SUMMARY

Aspects of an embodiment of the present invention disclose a method, computer program product, and computing system for managing e-mail messages between related e-mail accounts. An e-mail message is received from a first e-mail account of a user. It is determined that the e-mail message should be listed as a sent e-mail message in a second e-mail account of the user. The e-mail message is listed as a sent e-mail message in the second e-mail account.

### BRIEF DESCRIPTION OF THE SEVERAL VIEWS OF THE DRAWINGS

FIG. 1 is a functional block diagram of a computing system, in accordance with an embodiment of the present invention.

FIG. 2 is an exemplary user interface to an e-mail client program of an e-mail account on a client computer of FIG. 1, in accordance with one embodiment of the present invention.

FIG. 3 is an exemplary user interface to an e-mail client program of another e-mail account on a client computer of FIG. 1, in accordance with one embodiment of the present invention.

FIG. 4 depicts a flowchart of the steps of a related account management program executing within the computing system of FIG. 1, for registering one e-mail account of a user as related to another e-mail account of the user, in accordance with one embodiment of the present invention.

FIG. 5 depicts a flowchart of the steps of a related account management program executing within the computing system of FIG. 1, for listing sent e-mail messages from one e-mail account as sent e-mail messages in related e-mail accounts, in accordance with one embodiment of the present invention.

FIG. 6 is a block diagram of internal and external components of the server computers and the client computer of FIG. 1 in accordance with one embodiment of the present invention.

### DETAILED DESCRIPTION

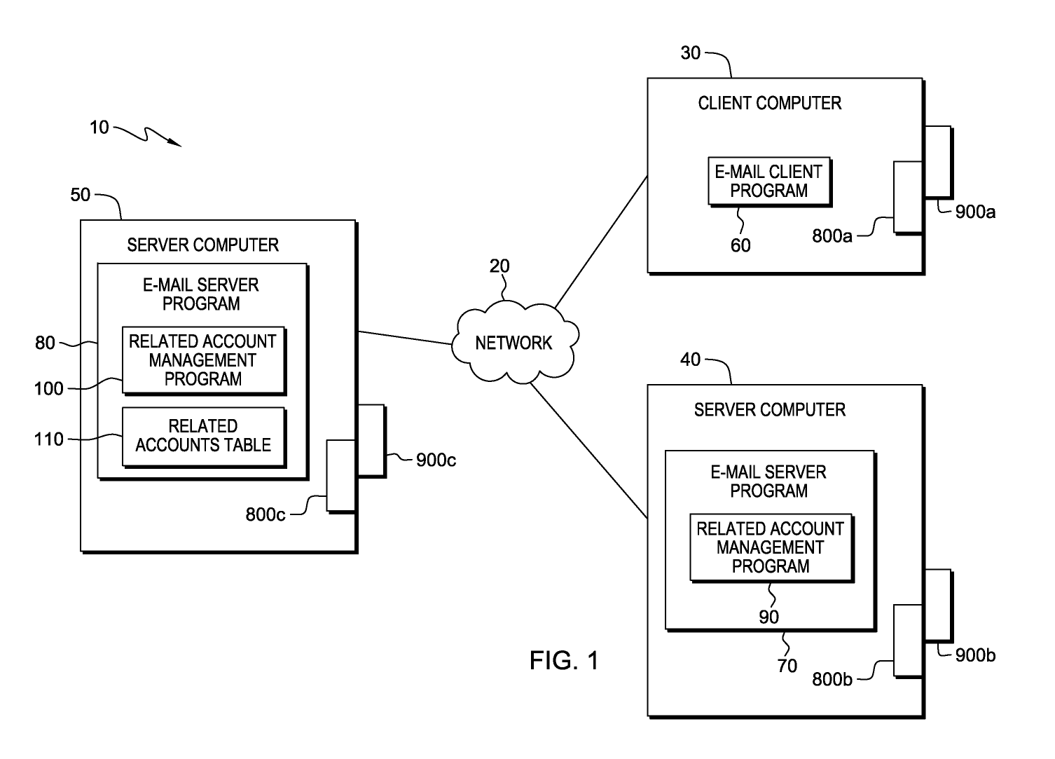

The present invention will now be described in detail with reference to the Figures. FIG. 1 depicts a computing system 10 in accordance with one embodiment of the present invention. FIG. 1 provides only an illustration of one embodiment and does not imply any limitations with regard to the environments in which different embodiments may be implemented.

In the depicted embodiment, computing system 10 includes client computer 30, server computer 40, and server computer 50 interconnected over network 20. Network 20 may be a local area network (LAN), a wide area network (WAN) such as the Internet, a combination of the two or any combination of connections and protocols that will support communications between client computer 30, server computer 40, and server computer 50 in accordance with embodiments of the invention. Network 20 may include wired, wireless, or fiber optic connections. Computing system 10 may include additional server computers, client computers, or other devices not shown.

Server computer 40 and server computer 50 may be management servers, web servers, or any other electronic devices or computing systems capable of receiving and sending data. In other embodiments, server computer 40 and server computer 50 may each represent a server computing system utilizing multiple computers as a server system, such as in a cloud computing environment. Server computer 40 contains e-mail server program 70 and related account management program 90. Server computer 50 contains e-mail server program 80 and related account management program 100.

Client computer 30 may be a desktop computer, laptop computer, tablet computer, personal digital assistant (PDA), or smart phone. In general, client computer 30 may be any electronic device or computing system capable of sending and receiving data, and communicating with server computer 40 and server computer 50 over network 20. E-mail client program 60 executes on client computer 30. E-mail client program 60 may be a dedicated client e-mail program, a web browser, or any program that can communicate with e-mail server program 70 and e-mail server program 80, and provide a user interface for composing and viewing e-mail messages.

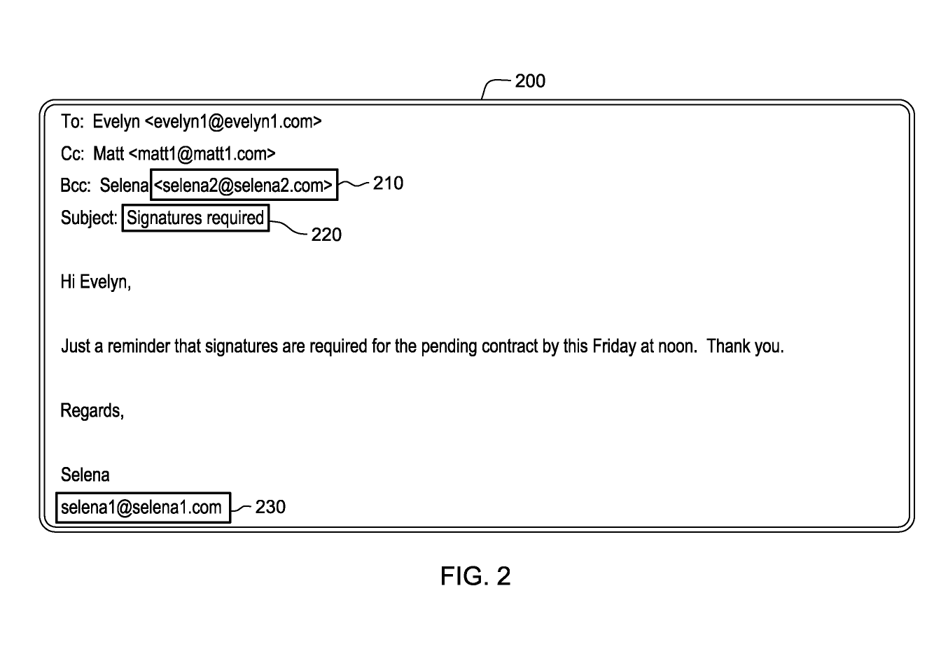

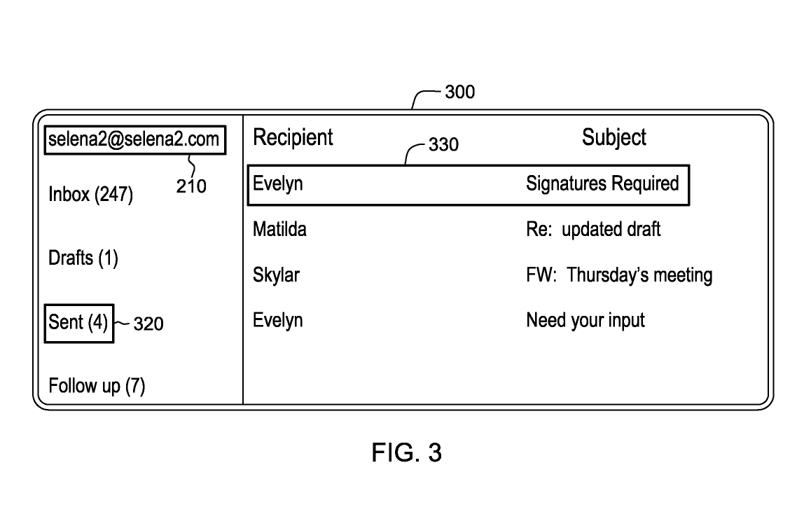

E-mail server program 70 and e-mail server program 80 operate to receive, forward, and manage e-mail messages from client computer 30. In one embodiment, a user has two e-mail accounts 210 and 230 (shown in FIGS. 2 and 3) with two different e-mail account providers, the two account provides are associated with e-mail server program 70 and e-mail server program 80, respectively.

E-mail server programs 70 and 80 also execute related account management programs 90 and 100, respectively, to indicate, in each related e-mail account (typically owned by the same person), actions taken in the other related e-mail account(s). Related account management programs 90 and 100 operate in the same manner.

Related account management program 100 also executes to register one e-mail account of a user as related to another e-mail account of the user. In one embodiment, related account management program 100 stores the e-mail accounts of the user that are related to e-mail account 210, such as e-mail account 230, in related accounts table 110. Related accounts table 110 is a database that contains the e-mail addresses of e-mail accounts related to e-mail account 210. Related accounts table 110 is created or updated by related account managements program 100 when an e-mail account is registered as related to e-mail account 210.

Related accounts table 110 is a database that may be written and read by related account management program 100. For example, related accounts table 110 may be a database such as an IBM® DB2® database or an Oracle® database. Related accounts table 110 is located on server computer 50. In other embodiments, related accounts table 110 may be located on another system or another computing device, provided that related accounts table 110 is accessible to related account management program 100. In one embodiment, related account management program 100 and related account management program 90 each generate and update a related accounts table in the same manner.

In one embodiment, related account management program 100 receives an e-mail message from e-mail server program 70 sent using e-mail account 230. In one embodiment of the present invention, related account management program 100 determines that the e-mail message should be listed as a “sent” e-mail message in related e-mail account(s) (such as related e-mail account 210 of the same owner) because the owner of the accounts previously registered the sender user account/address for this service.

Thus, in this embodiment, the owner of e-mail account 210 preregistered the e-mail address (the e-mail address of e-mail account 230 of the user in the “from” field) as an account that is related to e-mail account 210 of the user. In another embodiment, related account management program 90 adds, to the content or metadata of the e-mail message sent from e-mail account 230, a security token to indicate that the e-mail message should be listed as a “sent” e-mail message in related e-mail account(s) (such as related e-mail account 210 of the same owner). For example, related account management program 90 adds the token to the e-mail message when the e-mail address of e-mail account 210 of the user is included in the “To”, “BCC”, or “CC” fields and was preregistered as a related account with e-mail account 230 of the user. In yet another embodiment, the indication may be one half of a public/private key in the header or metadata of the e-mail message.

In another embodiment, e-mail account 210 and e-mail account 230 have been registered as related by the user. Related account management program 100 receives an indication from e-mail server program 70 that an action has been taken in e-mail account 230. Related account management program 100 indicates in e-mail account 210 the action taken in e-mail account 230. In one embodiment, the action taken in e-mail account 230 may be reading a received e-mail message, forwarding a received e-mail message, or replying to a received e-mail message.

If the action taken in e-mail account 230 is taken on an e-mail message that has been received by e-mail account 230 and e-mail account 210, the indication from e-mail server program 70 comprises an instruction to indicate the action taken in e-mail account 210. In an example, if a user using e-mail account 230 reads an e-mail message received by e-mail account 230 and e-mail account 210, e-mail server program 70 sends an instruction to related account management program 100 to indicate the e-mail message as read in e-mail account 210. Related account management program 100 receives the instruction. In response to receiving the instruction, related account management program 100 indicates the e-mail message as read in e-mail account 210.

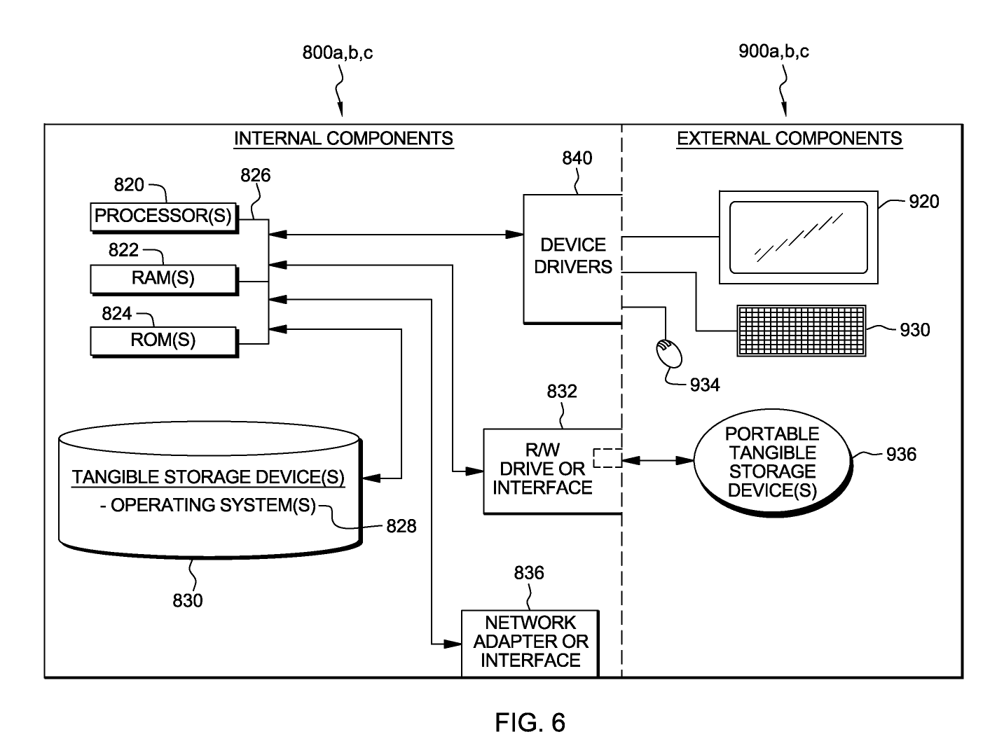

Client computer 30, server computer 40, and server computer 50 each maintain respective internal components 800a, 800b, and 800c, and respective external components 900a, 900b, and 900c. In general, client computer 30, server computer 40, and server computer 50 can be any computing system as described in further detail with respect to FIG. 6.

FIG. 2 is an exemplary user interface to e-mail client program 60 in accordance with one embodiment of the present invention. User interface 200 is an interface to e-mail account 230 of the user that allows the user to compose and view e-mail messages. User interface 200 is displaying an e-mail composed by the user and sent from e-mail account 230 of the user. Subject line 220 indicates the subject of the sent e-mail message (“Signatures required”). The user included the e-mail address of e-mail account 210 in the “BCC” field of the sent e-mail message. E-mail account 230 and e-mail account 210 have been configured as related e-mail accounts by the user.

FIG. 3 is an exemplary user interface to e-mail client program 60 in accordance with one embodiment of the present invention. User interface 300 is an interface that allows a user to view e-mail messages associated with an e-mail account that are organized and stored in folders. User interface 300 is displaying sent folder 320 of e-mail account 210 of the user. E-mail account 210 received the e-mail message shown in FIG. 2. E-mail message 330 is listed as a sent e-mail message (e.g., it appears in sent folder 320 of e-mail account 210 of the user) because the user of e-mail account 210 preregistered the e-mail address (the e-mail address of e-mail account 230 of the user) in the “from” field in FIG. 2 as an account that is related to e-mail account 210 of the user.

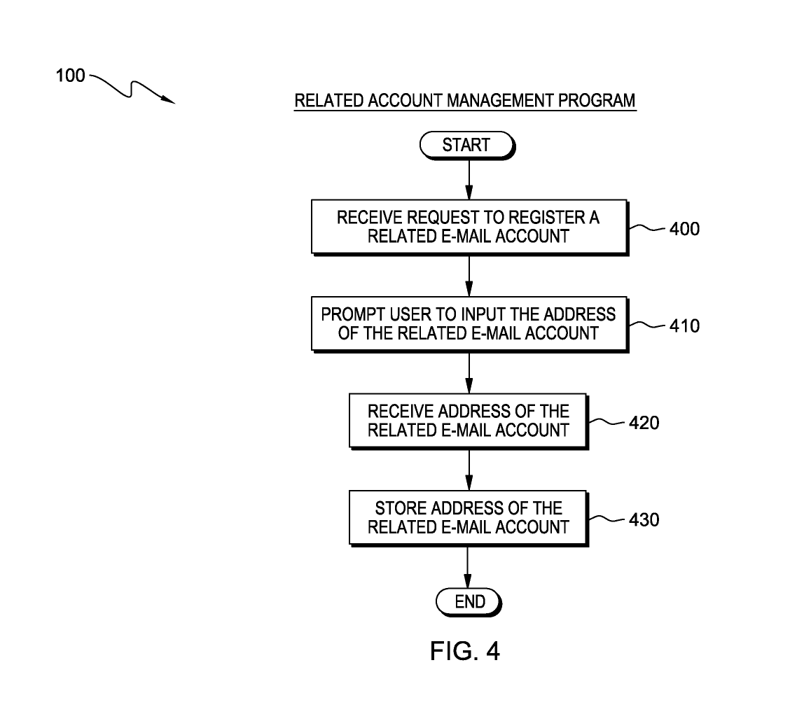

FIG. 4 depicts a flowchart of the steps of related account management program 100 executing within the computing system of FIG. 1, for registering one e-mail account of a user as related to another e-mail account of the user, in accordance with one embodiment of the present invention.

In step 400, related account management program 100 receives a request to register a related e-mail account from e-mail client program 60 over network 20. E-mail client program 60 sends to related account management program 100 the request, in response to the user selecting a registration function in e-mail client program 60 on client computer 30.

In response to receiving the request to register a related e-mail, related account management program 100 sends to e-mail client program 60 a request to prompt the user to input the e-mail address of the related e-mail account (step 410).

In step 420, related account management program 100 receives from e-mail client program 60 the e-mail address of the related account.

In step 430, related account program 100 stores the e-mail address of the related e-mail account in related accounts table 110 so related account management program 100 may access the e-mail address of the related e-mail account.

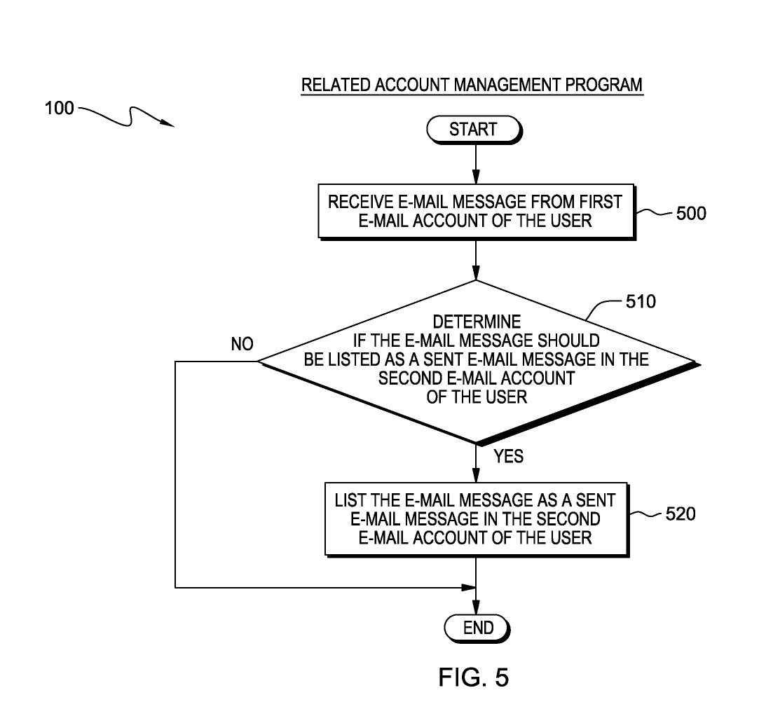

FIG. 5 depicts a flowchart of the steps of related account program 100 executing within the computing system of FIG. 1, for listing sent e-mail messages from one e-mail account as sent e-mail messages in related e-mail accounts, in accordance with one embodiment of the present invention.

Initially, a user at client computer 30 configures e-mail account 230 and e-mail account 210 of the user as related e-mail accounts, using e-mail client program 60. In one embodiment, the user configures e-mail account 230 and e-mail account 210 as related e-mail accounts so that the two related e-mail accounts share an identity using a one time authentication. In another embodiment, an authentication method such as OAuth may be used to configure the e-mail accounts. OAuth is an open standard for authentication, which provides a process for end-users to authorize third-party access to their server resources without sharing their credentials (such as a username and password pair) using user-agent redirections. Configuration of two or more e-mail accounts so that they are related could be a preset setting selected once by the user, or it could be a setting selected by the user each time he or she uses related account management program 100.

After the related e-mail accounts are configured, e-mail messages that are sent from one related account to another may also contain an indication that the e-mail message should be listed as a sent e-mail message in the e-mail account receiving the e-mail message.

The user at client computer 30 composes an e-mail message in e-mail account 230 of the user, including entry of at least the e-mail address of e-mail account 210 of the user in a recipient address field (e.g., “To”, “CC”, or “BCC”) of the e-mail, using e-mail client program 60. In one embodiment, e-mail client program 60 is a dedicated client e-mail program for e-mail account 230 that sends the e-mail message to e-mail server program 80 over network 20. In another embodiment, e-mail client program 60 is a web browser that allows the user to access e-mail server program 80 and draft an e-mail message in a user interface operating on client computer 30.

In one embodiment, the e-mail message contains the e-mail address of e-mail account 230 of the user in the “from” field of the e-mail message. In other embodiments, the e-mail message contains an indication that the e-mail message should be listed as a sent e-mail message in e-mail account 210 of the user. For example, the indication is a security token added to the e-mail message by the related account management program 90. In another example, the indication is one half of a public/private key in the header or metadata of the e-mail message.

In step 500, related account management program 100 receives the e-mail message, from e-mail server program 80. In another embodiment, related account management program 100 receives the e-mail message directly from e-mail client program 60.

Related account management program 100 determines if the e-mail message should be listed as a sent e-mail message in e-mail account 210 of the user (decision 510). In one embodiment, related account management program 100 determines if the e-mail account (listed in the “from” field) was previously registered as an account that is related to e-mail account 210 of the user. Related account management program 100 retrieves from related accounts table 110 the e-mail addresses of any accounts related to e-mail account 210 to determine if a retrieved e-mail address matches the e-mail account listed in the “from” field. In another embodiment, related account management program 100 determines if the e-mail message contains an indication that the e-mail message should be listed as a sent e-mail message in e-mail account 210 of the user. In other embodiments, related account management program 100 may determine if the sender of the e-mail (listed in the “from” field) was previously registered as an account that is related to e-mail account 210 of the user or if the e-mail message contains an indication that the e-mail message should be listed as a sent e-mail message in e-mail account 210 of the user in decision 510.

If related account management program 100 determines that the e-mail message should be listed as a sent e-mail message in e-mail account 210 of the user, (decision 510, Yes branch), related account management program 100 proceeds to step 520. If related account management program 100 determines that the e-mail message should not be listed as a sent e-mail message in e-mail account 210 of the user, (decision 510, No branch), related account management program 100 ends. In one embodiment, the e-mail message is sent to e-mail server program 80 for normal processing of incoming e-mail messages. For example, the e-mail message will be listed as received e-mail in the inbox of e-mail account 210 of the user.

In step 520, related account management program 100 lists the e-mail message as a sent e-mail message in e-mail account 210 of the user. In one embodiment, related account management program 100 sends the e-mail message to the sent folder of e-mail account 210 of the user. In another embodiment, during the configuration process, the user may indicate that all e-mail messages from a specific related account will be sent to a specific folder. For example, the user may select to send all e-mails from his or her business e-mail account to a preselected folder such as a business e-mail folder.

In one embodiment, when a user accesses e-mail account 210, the user accesses the e-mail message in the sent folder. In another embodiment, the user accesses the e-mail message in a separate folder preselected during the configuration process.

FIG. 6 is a block diagram of internal and external components of client computer 30, server computer 40, and server computer 50 in accordance with one embodiment of the present invention.

Client computer 30, server computer 40, and server computer 50 include respective sets of internal components 800a,b,c and external components 900a,b,c, illustrated in FIG. 5. Each of the sets of internal components 800a,b,c includes one or more processors 820, one or more computer-readable RAMs 822 and one or more computer-readable ROMs 824 on one or more buses 826, one or more operating systems 828 and one or more computer-readable tangible storage devices 830. The one or more operating systems 828 and e-mail client program 60 (for client computer 30), e-mail server program 70 and related account management program 90 (for server computer 40), and e-mail server program 80 and related account management program 100 (for server computer 50) are stored on one or more of the respective computer-readable storage devices 830 for execution by one or more of the respective processors 820 via one or more of the respective RAMs 822 (which typically include cache memory). In the illustrated embodiment, each of the computer-readable storage devices 830 is a magnetic disk storage device of an internal hard drive. Alternatively, each of the computer-readable storage devices 830 is a semiconductor storage device such as ROM 824, EPROM, flash memory or any other computer-readable storage device that can store a computer program and digital information.

Each set of internal components 800a,b,c also includes a R/W drive or interface 832 to read from and write to one or more portable computer-readable storage devices 936 such as a CD-ROM, DVD, memory stick, magnetic tape, magnetic disk, optical disk or semiconductor storage device. E-mail client program 60 (for client computer 30), e-mail server program 70 and related account management program 90 (for server computer 40), and e-mail server program 80 and related account management program 100 (for server computer 50) can be stored on one or more of the respective portable computer-readable storage devices 936, read via the respective R/W drive or interface 832 and loaded into the respective hard drive or semiconductor storage device 830. The term “computer-readable storage device” does not encompass a copper cable, optical fiber or wireless media, to propagate signals.

Each set of internal components 800a,b,c also includes a network adapter or interface 836 such as a TCP/IP adapter card or wireless communication adapter (such as a 4G wireless communication adapter using OFDMA technology). E-mail client program 60 (for client computer 30), e-mail server program 70 and related account management program 90 (for server computer 40), and e-mail server program 80 and related account management program 100 (for server computer 50) can be downloaded to the respective computing/processing devices from an external computer or external storage device via a network (for example, the Internet, a local area network or other, wide area network or wireless network) and network adapter or interface 836. From the network adapter or interface 836, the programs are loaded into the respective hard drive or semiconductor storage device 830. The network may comprise copper wires, optical fibers, wireless transmission, routers, firewalls, switches, gateway computers and/or edge servers.

Each of the sets of external components 900a,b,c includes a display screen 920, a keyboard or keypad 930, and a computer mouse or touchpad 934. Each of the sets of internal components 800a,b,c also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in storage device 830 and/or ROM 824).

The programs can be written in various programming languages (such as Java, C+) including low-level, high-level, object-oriented or non object-oriented languages. Alternatively, the functions of the programs can be implemented in whole or in part by computer circuits and other hardware (not shown).

Based on the foregoing, a computer system, method and program product have been disclosed for managing e-mail messages between related e-mail accounts. However, numerous modifications and substitutions can be made without deviating from the scope of the present invention. Therefore, the present invention has been disclosed by way of example and not limitation.

What is claimed is:

1. A method for managing e-mail messages between related e-mail accounts, the method comprising:
receiving an e-mail message from a first e-mail account of a user;
determining, by one or more processors, that the e-mail message should be listed as a sent e-mail message in a second e-mail account of the user; and
listing the e-mail message as a sent e-mail message in the second e-mail account.

2. The method of claim 1, further comprising the prior step of registering the first e-mail account and the second e-mail account as related e-mail accounts, and wherein the one or more processors determine that the e-mail message should be listed as a sent e-mail message in the second e-mail account of the user based on a “from” address of the e-mail message matching the registration of the first e-mail account.

3. The method of claim 1, wherein the e-mail message includes an indication that the e-mail message should be listed as a sent e-mail message in the second e-mail account of the user, and wherein the one or more processors determine that the e-mail message should be listed as a sent e-mail message in a second e-mail account of the user based on the indication.

4. The method of claim 3 wherein the indication comprises a security token added to the e-mail message.

5. The method of claim 1, wherein the step of listing the e-mail message as a sent e-mail message in the second e-mail account comprises listing the e-mail message in a preselected folder in the second e-mail account.

6. The method of claim 1, wherein the step of listing the e-mail message as a sent e-mail message in the second e-mail account comprises listing the e-mail message in the sent folder in the second e-mail account.

7. The method of claim 1, the method further comprising:
receiving an indication of an action taken on a second e-mail message in the first e-mail account of the user, wherein the second e-mail message is received by both the first e-mail account and the second e-mail account of the user;
determining, by the one or more processors, the action taken on the second e-mail message; and
indicating, in the second e-mail account of the user, the action taken on the second e-mail message.

8. The method of claim 7, wherein the action taken on the second e-mail message is the second e-mail message being read.

9. A computer program product for managing e-mail messages between related e-mail accounts, the computer program product comprising:
one or more computer-readable storage devices and program instructions stored on the one or more computer-readable storage devices, the program instructions comprising:
program instructions to receive an e-mail message from a first e-mail account of a user;
program instructions to determine that the e-mail message should be listed as a sent e-mail message in a second e-mail account of the user; and
program instructions to list the e-mail message as a sent e-mail message in the second e-mail account.

10. The computer program product of claim 9, further comprising program instructions stored on the one or more computer-readable storage devices, to register the first e-mail account and the second e-mail account as related e-mail accounts, and wherein the program instructions to determine that the e-mail message should be listed as a sent e-mail message in the second e-mail account of the user comprise program instructions to determine that the e-mail message should be listed as a sent e-mail message in the second e-mail account of the user based on a “from” address of the e-mail message matching the registration of the first e-mail account.

11. The computer program product of claim 9, wherein the e-mail message includes an indication that the e-mail message should be listed as a sent e-mail message in the second e-mail account of the user, and wherein the program instructions to determine that the e-mail message should be listed as a sent e-mail message in a second e-mail account of the user comprise program instructions to determine that the e-mail message should be listed as a sent e-mail message in a second e-mail account of the user based on the indication.

12. The computer program product of claim 11 wherein the indication comprises a security token added to the e-mail message.

13. The computer program product of claim 9, wherein the program instructions to list the e-mail message as a sent e-mail message in the second e-mail account comprise program instructions to list the e-mail message in a preselected folder in the second e-mail account.

14. The computer program product of claim 9, wherein the program instructions to list the e-mail message as a sent e-mail message in the second e-mail account comprise program instructions to list the e-mail message in the sent folder in the second e-mail account.

15. The computer program product of claim 9, further comprising:
program instructions, stored on the one or more computer-readable storage devices, to receive an indication of an action taken on a second e-mail message in the first e-mail account of the user, wherein the second e-mail message is received by both the first e-mail account and the second e-mail account of the user;
program instructions, stored on the one or more computer-readable storage devices, to determine the action taken on the second e-mail message; and
program instructions, stored on the one or more computer-readable storage devices, to indicate, in the second e-mail account of the user, the action taken on the second e-mail message.

16. The computer program product of claim 15, wherein the action taken on the second e-mail message is the second e-mail message being read.

17. A computer system for managing e-mail messages between related e-mail accounts, the computer system comprising:
one or more computer processors, one or more computer-readable memory devices, one or more computer-readable storage devices, and program instructions stored on the computer-readable storage devices for execution by at least one of the one or more processors via the one or more memory devices, the program instructions comprising:
program instructions to receive an e-mail message from a first e-mail account of a user;
program instructions to determine that the e-mail message should be listed as a sent e-mail message in a second e-mail account of the user; and
program instructions to list the e-mail message as a sent e-mail message in the second e-mail account.

18. The computer system of claim 17, further comprising program instructions stored on the one or more computer-readable storage devices for execution by at least one of the one or more processors via the one or more memory devices, to register the first e-mail account and the second e-mail account as related e-mail accounts, and wherein the program instructions to determine that the e-mail message should be listed as a sent e-mail message in the second e-mail account of the user comprise program instructions to determine that the e-mail message should be listed as a sent e-mail message in the second e-mail account of the user based on a “from” address of the e-mail message matching the registration of the first e-mail account.

19. The computer system of claim 17, wherein the e-mail message includes an indication that the e-mail message should be listed as a sent e-mail message in the second e-mail account of the user, and wherein the program instructions to determine that the e-mail message should be listed as a sent e-mail message in a second e-mail account of the user comprise program instructions to determine that the e-mail message should be listed as a sent e-mail message in a second e-mail account of the user based on the indication.

20. The computer system of claim 19, wherein the indication comprises a security token added to the e-mail message.

21. The computer system of claim 17, wherein the program instructions to list the e-mail message as a sent e-mail message in the second e-mail account comprise program instructions to list the e-mail message in a preselected folder in the second e-mail account.

22. The computer program product of claim 17, wherein the program instructions to list the e-mail message as a sent e-mail message in the second e-mail account comprise program instructions to list the e-mail message in the sent folder in the second e-mail account.

23. The computer system of claim 17, further comprising:
program instructions, stored on the computer-readable storage devices for execution by at least one of the one or more processors via the one or more memory devices, to receive an indication of an action taken on a second e-mail message in the first e-mail account of the user, wherein the second e-mail message is received by both the first e-mail account and the second e-mail account of the user;
program instructions, stored on the computer-readable storage devices for execution by at least one of the one or more processors via the one or more memory devices, to determine the action taken on the second e-mail message; and
program instructions, stored on the computer-readable storage devices for execution by at least one of the one or more processors via the one or more memory devices, to indicate, in the second e-mail account of the user, the action taken on the second e-mail message.

24. The computer program product of claim 23, wherein the action taken on the second e-mail message is the second e-mail message being read.
